(19) United States
(12) Patent Application Publication
(10) Pub. No.: US 2018/0253764 A1
(43) Pub. Date: Sep. 6, 2018

(54) METHOD AND SYSTEM OF RECORDING GUEST FEEDBACK ON A CAPTIVE PORTAL BEFORE GRANTING INTERNET ACCESS

(71) Applicants: VIVEK KUMAR, MURRYSVILLE, PA (US); DEEPENDRA TEWARI, GHAZIABAD (IN); ASHIMA SOOD, LUDHIANA (IN)

(72) Inventors: VIVEK KUMAR, MURRYSVILLE, PA (US); DEEPENDRA TEWARI, GHAZIABAD (IN); ASHIMA SOOD, LUDHIANA (IN)

(21) Appl. No.: 15/708,108

(22) Filed: Sep. 18, 2017

Related U.S. Application Data
(60) Provisional application No. 62/396,228, filed on Sep. 19, 2016.

(51) Int. Cl. G06Q 30/02; H04W 48/18

(52) U.S. Cl. CPC G06Q 30/0282; H04W 84/12; H04W 48/18

(57) ABSTRACT

In one aspect, a computer system useful for recording guest feedback on a captive portal before granting internet access through a venue's Wi-Fi hotspot includes a processor. The processor is communicatively coupled with a memory containing instructions when executed on the processor, causes the processor to perform operations that: provide a captive portal, wherein the captive portal comprises a web page that is shown before allowing a guest's computing device's web browser to access the Internet via a venue's Wi-Fi network; with the web page provided by the captive portal, presenting the guest with a feedback form, wherein the feedback form is hosted locally in a local, gateway controller; and obtaining a guest's feedback from a guest input in the feedback form.

### CLAIM OF PRIORITY & INCORPORATION BY REFERENCE

This application claims priority to U.S. Provisional Application No. 62/396,228, titled and METHOD AND SYSTEM OF RECORDING GUEST FEEDBACK ON A CAPTIVE PORTAL BEFORE GRANTING INTERNET ACCESS filed on 19 Sep. 2016. This provisional application is incorporated'by reference in its entirety.

### BACKGROUND

### Field of the Invention

This application relates generally to computer networks, and more specifically to a system, article of manufacture and method of recording guest feedback on a captive portal before granting internet access.

### Description of the Related Art

Various online websites publish crowd-sourced reviews about local businesses and/or other venues. Quite often negative reviews include content that a venue may have been able to manage early on in a customer/guest experience. For example, a hotel room may have an issue that is easily resolvable if the on-duty staff is made aware of it in a timely manner. A venue may wish to implement a method to analyze and/or manage guest feedback. However, current forms of guest feedback involve paper forms that may not be analyzed for weeks or months by a non-local corporate office. Accordingly, current methods of dealing with potential causes of a guest's negative experience may not be made known to the venue in a timely enough manner to prevent the guest from publishing complaints in online forums. At the same time, guests often use the venue's local Wi-Fi Hotspot. Accordingly, improvements to recording and analyzing guest feedback are desired.

### BRIEF SUMMARY OF THE INVENTION

In one, aspect, a computer system useful for recording guest feedback on a captive portal before granting internet access through a venue's Wi-Fi hotspot includes a processor. The processor is communicatively coupled with a memory containing instructions when executed'on the processor, causes the processor to perform operations that provide a captive portal, wherein the captive portal comprises a web page that is shown before allowing a guest's computing device's web browser to access the Internet via a venue's Wi-Fi network; with the web page provided by the captive portal, presenting the guest with a feedback form, wherein the feedback form is hosted locally in a local gateway controller; and obtaining a guest's feedback from a guest input in the feedback form.

### BRIEF DESCRIPTION OF THE DRAWINGS

FIG. 1 illustrates an example process for obtaining guest feedback on a captive portal, according to some embodiments.

FIG. 2 illustrates an example process for aggregating and reporting guest feedback, according to some embodiments.

FIG. 3 illustrates an example process for pre-specifying types) of guest feedback to report, according to some embodiments.

FIG. 4 depicts an exemplary computing system that can be configured to perform any one of the processes provided herein.

FIG. 5 is a block diagram of a sample computing environment that can be utilized to implement various embodiments.

FIGS. 6-17 illustrate example screen shots of embodiments of the processes and systems provided herein, according to some embodiments.

The Figures described above are a representative set, and are not an exhaustive with respect o embodying the invention.

### DESCRIPTION

Disclosed are a system, method, and article of manufacture of recording guest feedback on a captive portal before granting internet access. The following description is presented to enable a person of ordinary skill in the art to make and use the various embodiments. Descriptions of specific devices, techniques, and applications are provided only as, examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### DEFINITIONS

Example definitions for some embodiments are now provided.

Captive portal can be a special web page that is shown before using the Internet normally. The portal is often used to present a login page. This can be done by intercepting data packets, regardless of address or port, until the user opens a browser and tries to access the web.

Controller can be a routing device that can manage and direct the flow of traffic between the WLAN connected hosts and the Internet via the WAN port and provide services such as Authentication, Authorization, Auditing, Advertising, Analytics etc. Such services maybe locally hosted within the same memory space or hosted outside the routing device and referred to via the LAN or WAN ports.

Hotspot (Wi-Fi) can be a Wi-Fi network access point or area. In one example, a hot pot can be a site that offers Internet access over a wireless local area network (WLAN) through the use of a router connected to a link to an Internet service provider.

Local area network (LAN) can be a computer network that interconnects computers within a limited area such as home, school, computer laboratory, or office building, using network media.

Port can be an application-specific or process-specific software construct serving as a communications endpoint in a computer's host operating system router. As used herein, a port can be a physical port or a virtual port.

Virtual LAN can be as group of devices on one or more LANs that are configured to communicate as if they were attached to the same wire, when in fact they are located on a number of different LAN segments.

Virtual port can be an internet protocol (IP) alias bound to a physical port. For example, it can share all of the network settings (except the IP address) with an associated physical port.

Whitelist can be a list or register of those that are being provided a particular privilege, service, mobility, access or recognition. It is noted that, in some embodiments, there can be a device whitelist and a link whitelist.

Wi-Fi can be a local area wireless technology that allows an electronic device to exchange data or connect to the internet (e.g. using 2.4 GHz UHF and 5 GHz SHF radio waves).

Wireless local area network (WLAN) can be a wireless computer network that links two or more devices using a wireless distribution method within a limited area such as a home, school, airport terminal, office building, etc.

Example Methods and Processes

In one example, a guest (e.g. a hotel guest, etc.) can provide feedback to a venue using a captive portal. This can be done before the guest is provided internet access using a Wi-Fi Hotspot. In this way, a venue owner can collect and analyze feedback from guests in real-time (e.g. assuming networking latency, processing latency, etc,), before the feedback is provided/communicated to review sites. Accordingly, a venue owner can better engage with guests. This allows for a two-way dialog to be opened between the user and the venue owner without requiring any invasive actions such as inter alis opening a third-party website etc. For example, this can be done when guests are at the establishment. Moreover, example embodiments may not require invasive actions such as, inter alio, opening a third-party website, downloading and installing a phone application, etc. A guest can provide feedback to the venue owners and/or management in an interactive manner such that these entities are provided a chance to take corrective measures as required.

The guest feedback can be aggregated and displayed as daily, weekly, monthly and/or year-wise statistics (e.g. in the form of a stacked bar graph for each month of the year along with total count across each of the three categories for all months of that year, etc.). The data recorded is shown on a user interface (UI) within a locally-hosted configuration panel as well as a cloud-hosted configuration panel. Venue owners can opt via the configuration panel to, receive instant email alerts (and/or other forms of alerts such as, for example, text messages, voice mails, push notifications to a mobile application, instant messages, etc.) based on the type of feedback recorded. Venue, owners can also choose to look for the presence of certain keywords of their choice within the comments left by the guest. The venue owners can receive email alerts to their preregistered email addresses and their managers when such keywords are found in a guest's comments. Such matching keywords can be automatically highlighted in the email. The system can also scan the feedback text body for specific keywords and on basis of presence of such keywords, group the feedback into pre-defined categories to make it easier to analyze the feedback responses. For example, the system can see there are 4 feedbacks with keyword ‘toilet’ and ‘smell’ and aggregate them into a category like ‘House-keeping’. In another example, the system can see there are 7 feedbacks with room ‘217’ and can out them in a dynamically created category of ‘Room 217’, The system can also send out daily, weekly and monthly emails containing aggregated count of feedback and their types to the same list of addresses. The venue owner's dashboard can be both locally hosted as well as cloud based. Venue owners can view daily, weekly, monthly and/or yearly reports for easy analysis across each feedback category. Venue owners can switch backwards to the previous year or forward to the next year.

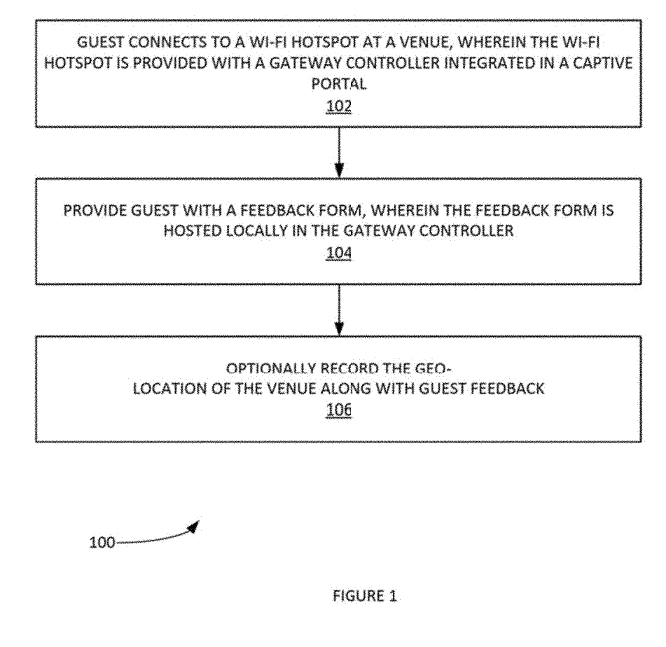

FIG. 1 illustrates an example process 100 for obtaining guest feedback on captive portal, according to some embodiments. In step 102, a guest (e.g. a web browser of the guest's computing device, etc.) connects to a Wi-Fi hotspot at a venue. The Wi-Fi hotspot is provided with a gateway controller integrated in a captive portal. In step 104, process 100 can provide guest with a feedback form. The feedback form is hosted locally in the gateway controller. The feedback form can be displayed user's browser after the user clicks on one of the smiley emojis for providing feedback. In step 106, process 100 can optionally record the geolocation of the venue along with guest feedback.

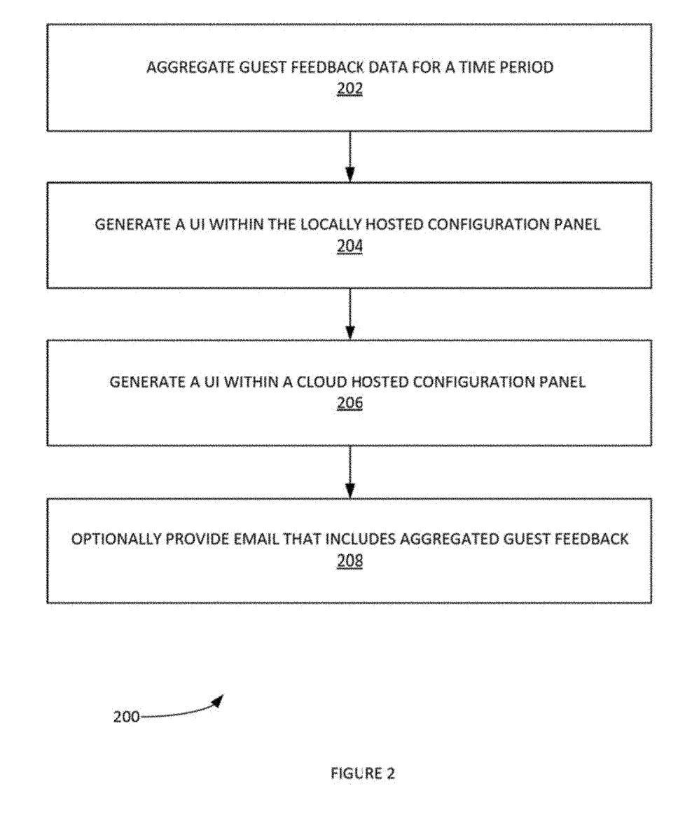

FIG. 2 illustrates an example process 200 for aggregating and reporting guest feedback according to some embodiments. In step 202, process 200 can aggregate guest feedback data for a time period. In step 204, process 200 can generate a user interface (UI) within the locally hosted configuration panel. In step 206, process 200 can generate a UI within a cloud hosted configuration panel. In step 208, process 200 can optionally provide an email that includes aggregated guest feedback.

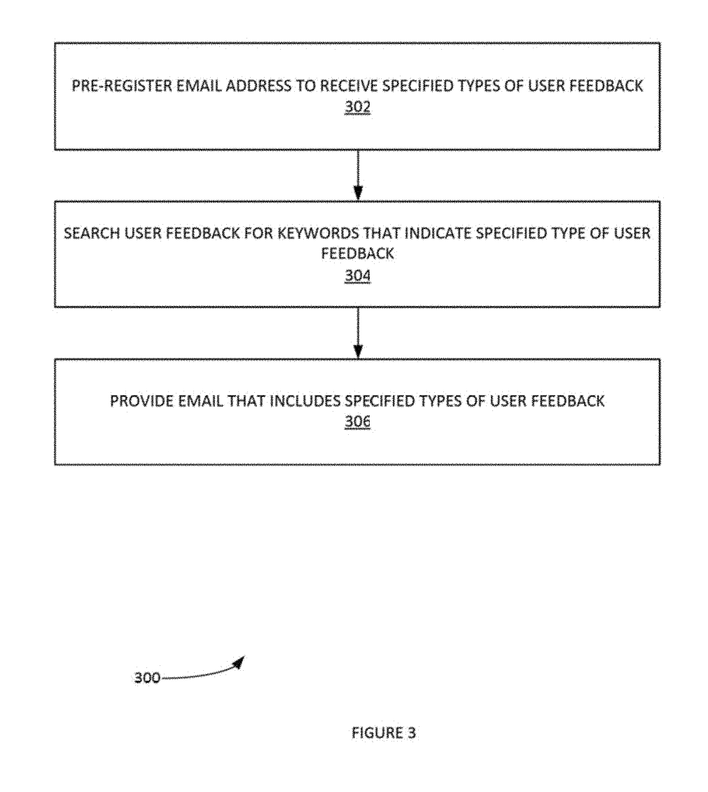

FIG. 3 illustrates an example process 300 for pre-specifying type(s) of guest feedback to report, according to some embodiments. In step 302, process 300 can pre-register an email address to receive specified types of user feedback. In step 304, process 300 carp search user feedback for keywords that indicate specified type of user feedback. In step 306, process 300 can provide an email that includes specified types of user feedback.

### Additional Exemplary Computer Architecture and Systems

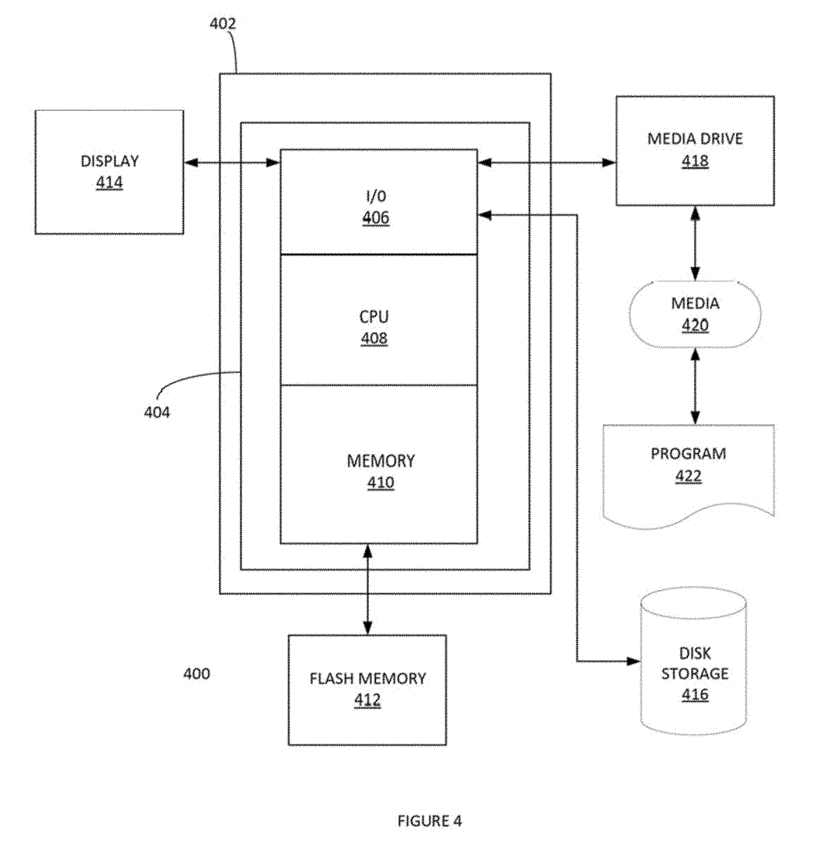

FIG. 4 depicts an exemplary computing system 400 that can be configured to perform any one of the processes provided herein. In this context, computing system 400 may include, for example, a processor, memory, storage, and I/O devices (e.g., monitor, keyboard, disk drive Internet connection, etc.). However computing system 400 may include circuitry or other specialized hardware for carrying out some or all aspects of the processes, In some operational settings, computing system 400 may be configured as a system that includes one or more units, each of which is configured to carry out some aspects of the processes either in software, hardware, or some combination thereof.

FIG. 4 depicts computing system 400 with a number of components that may be used to perform any of the processes described herein. The main system 402 includes a motherboard 404 having an I/O section 406, one or more central processing units (CPU) 408, and a memory section 410, which may have a flash memory card 412 related to it. The I/O section 406 can be connected to a display 414, a keyboard and/or other user input (not shown), a disk storage unit 416, and a media drive unit 418. The media drive unit 418 can read/write a computer-readable medium 420, which can contain programs 422 and/or data. Computing system 400 can include a web browser. Moreover, it is noted that computing system 400 can be configured to include additional systems in order to fulfill various functionalities. Computing system 400 can communicate with other computing devices based on various computer communication protocols such a Wi-Fi, Bluetooth® (and/or other standards for exchanging data over short d includes those using short-wavelength radio transmissions), USB, Ethernet, cellular, an ultrasonic local area communication protocol, etc.

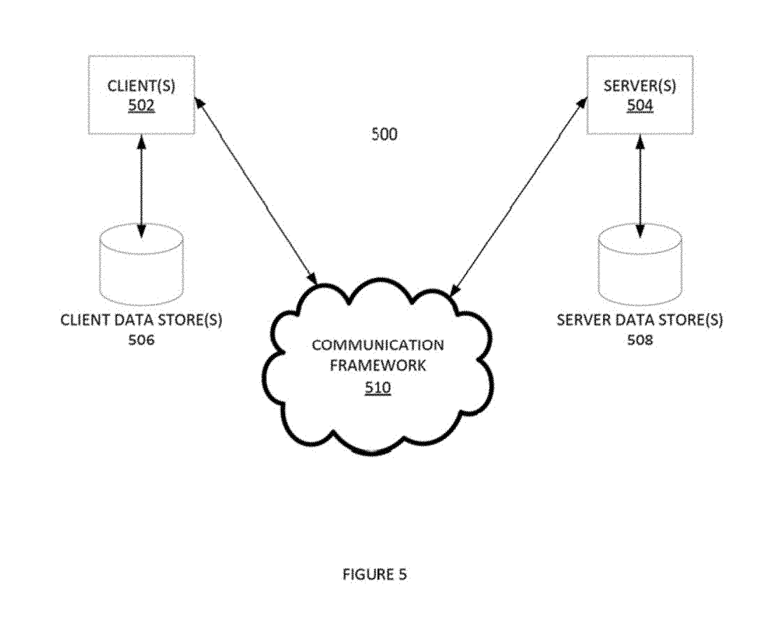

FIG. 5 is a block diagram f a sample computing environment 500 that can be utilized to implement various embodiments. The system 500 further illustrates a system that includes one or more client(s) 502. The client(s) 502 can be hardware and/or software (e.g., threads, processes, computing devices). The system 500 also includes one or more server(s) 504. The server(s) 504 can also be hardware and/or software (e.g., threads, processes, computing devices). One possible communication between a client 502 and a server 504 may be in the form of a data packet adapted to be transmitted between two or more computer processes. The system 500 includes a communication framework 51.0 that can be employed to facilitate communications between the client(s) 502 and the server(s) 504. The client(s) 502 are connected to one or more client data store(s) 506 that can be employed to store information local to the client(s) 502 Similarly, the server(s) 504 are connected to one or more server data store(s) 508 that can be employed to store information local to the server(s) 504. In some embodiments, system 500 can instead be a collection of remote computing services constituting a cloud-computing platform.

Example Screen Shots

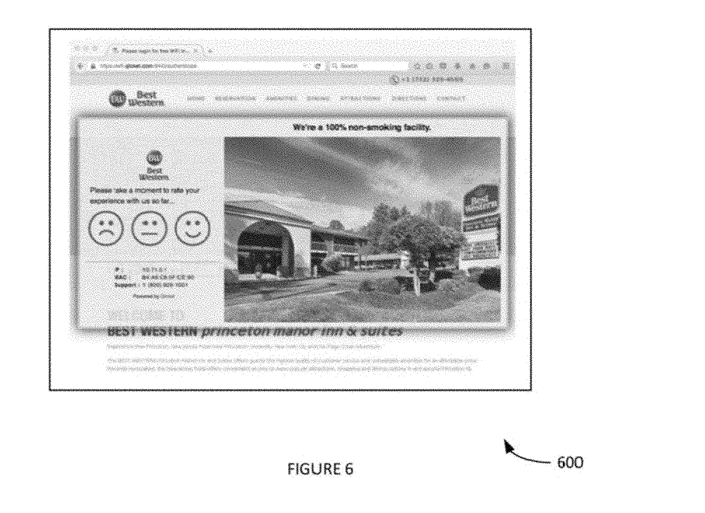

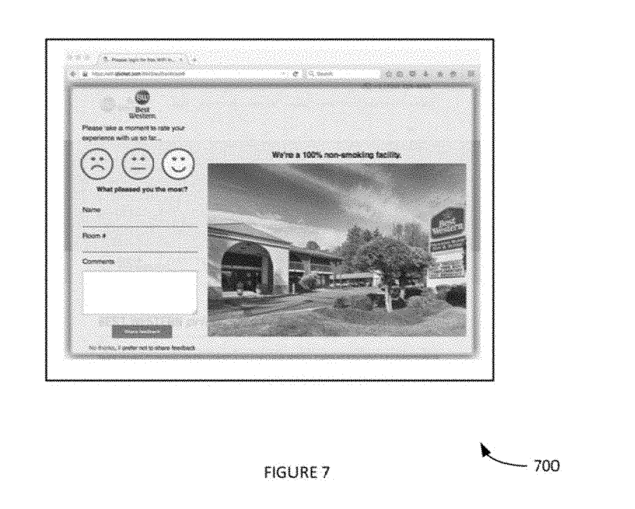

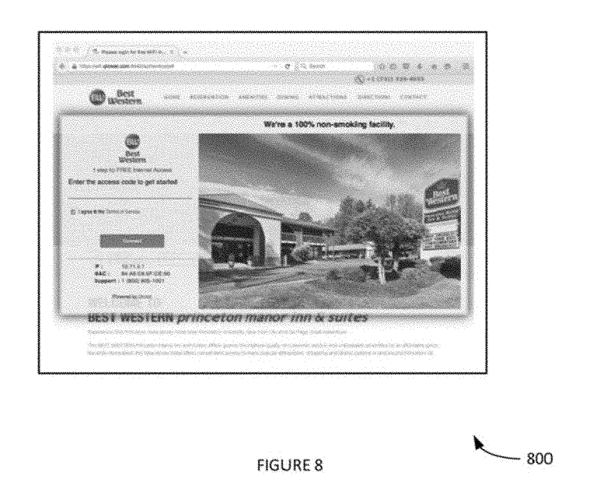

FIGS. 6-17 illustrate example screen shots of embodiments of the processes and systems provided herein. FIG. 6 shows a screen shot 600 that guests are presented with three (3) ‘smiley emoji’. The guest can click on one of the three smiley faces depicting delighted, neutral and disappointed sentiments with respect to the hotel's services. Each click on a smiley face is recorded as a vote in a local database by a controller. This information can be periodically synchronized to a cloud-based aggregated database. Once the guest has chosen a smiley indicating their experience, the guest can optionally choose to provide further details such as, inter alio: name, room number, comments, etc. as shown in screen shot 700 of FIG. 7. The guest can then proceed with the next steps of accessing the Internet through the captive portal as shown in screen shot 800 of FIG. 8.

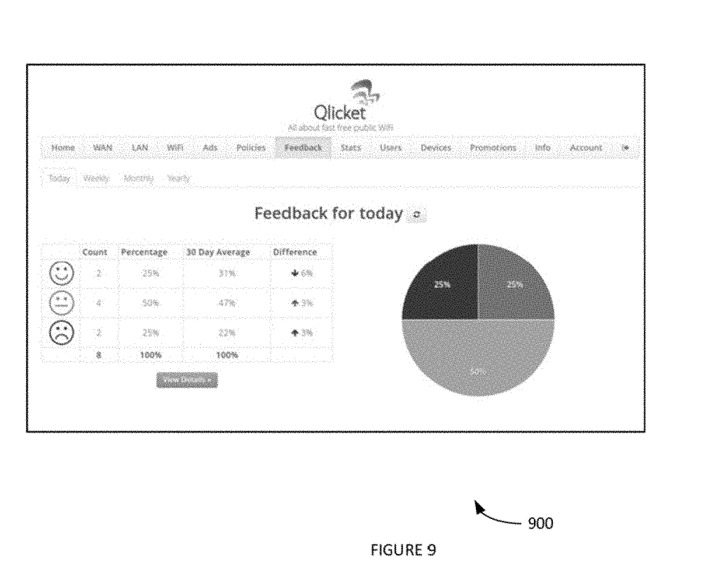

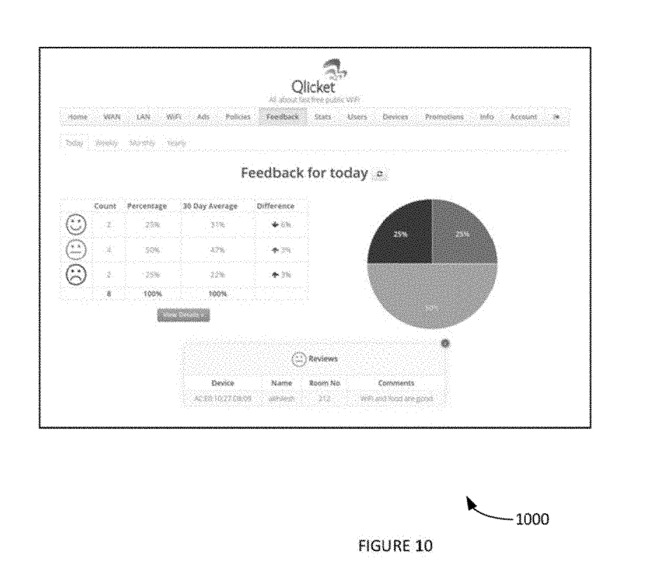

FIGS. 9 and 10 illustrate example screen shots 900 and 1300 of daily feedback forms, according to some embodiments.

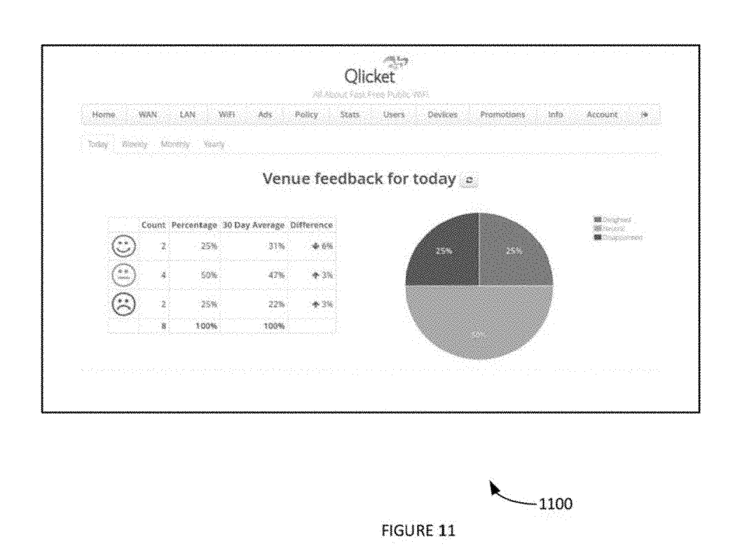

FIG. 11 illustrates an example screen shot 1100 of a daily view of recorded-guest feedback. The example screen shot displays a c rent day's statistics in the form of an interactive pie chart along with total count, a thirty (30) day average and/or percentage difference across each of the three categories. The example screen shot displays numeric feedback for a day, along with a pie chart graphic..

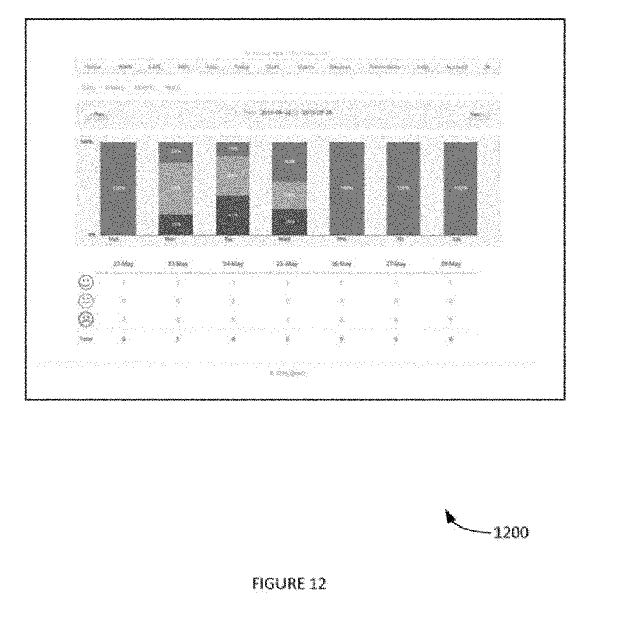

FIG. 12 illustrates an example shot 1200 that provides various options that enable a venue administrator to view weekly feedback.

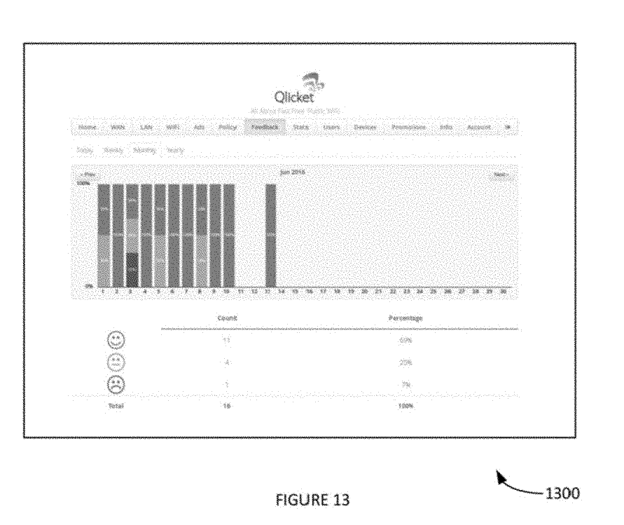

FIG. 13 of a monthly view of recorded-guest feedback. Example screen shot displays a set of month-wise statistics in the form of a stacked bar graph for each day of the month along with total count across each of the three categories for that month. The user has the option to switch backwards to the previous month or forward to the next month. The example screen shot enables the venue to see various trends. For example, September 4^{th} and 7^{th} were better days on average. The example screen shot can provide the names of employees who were on staff that day and/or which groups the hotel serving.

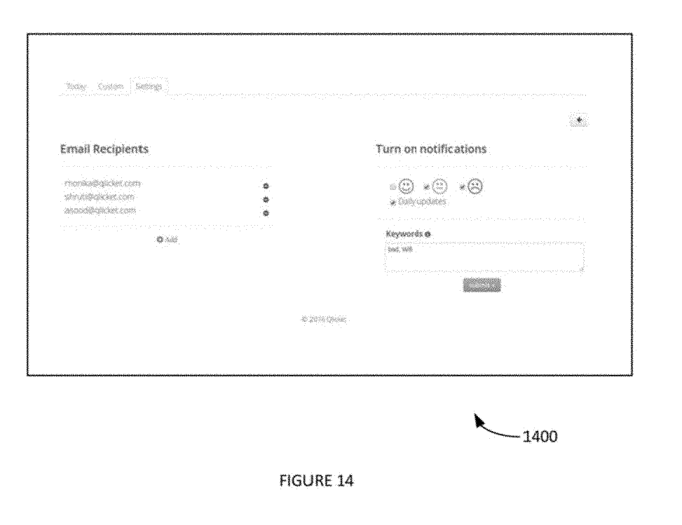

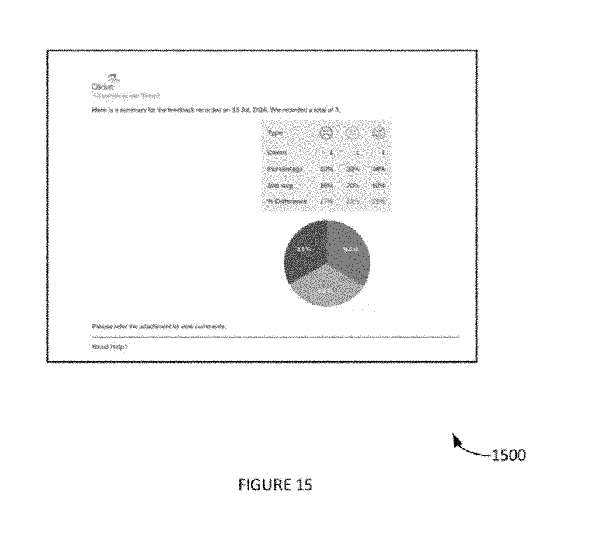

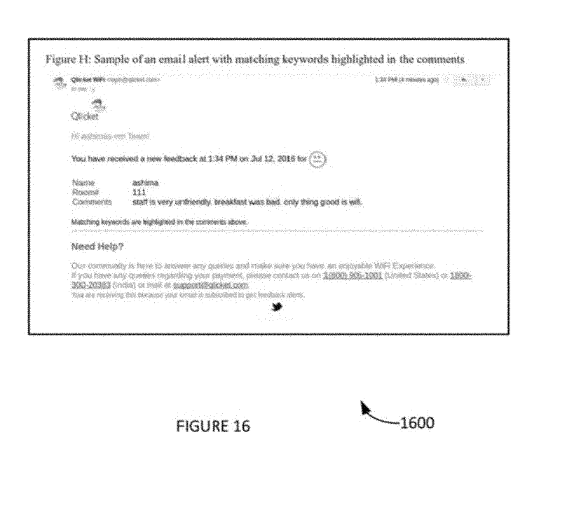

FIG. 14 illustrates an example screen shot 1400 of an option to register for email alerts for various types of feedback that are aggregated daily email. A venue administrator can set alerts to receive real-time updates of feedback, including of chosen smileys, daily (e.g. at the end of day) updates, and even of specific keywords (e.g. would be relevant if not all smileys are checked such that if a keyword was contained in a positive smiley, etc.), FIG. 15 illustrates an example screen shot 1500 of a sample of an aggregated daily email. FIG. 16 with an example screen shot 1600 illustrating shows instant email alerts. This enables a venue to correct an issue in real-time (e.g. assuming networking and/or processing latency, etc.), while the guest is at their property. It is noted that a guest does not need to take additional steps (e.g. calling the front desk, navigating to a third-party website, etc.).

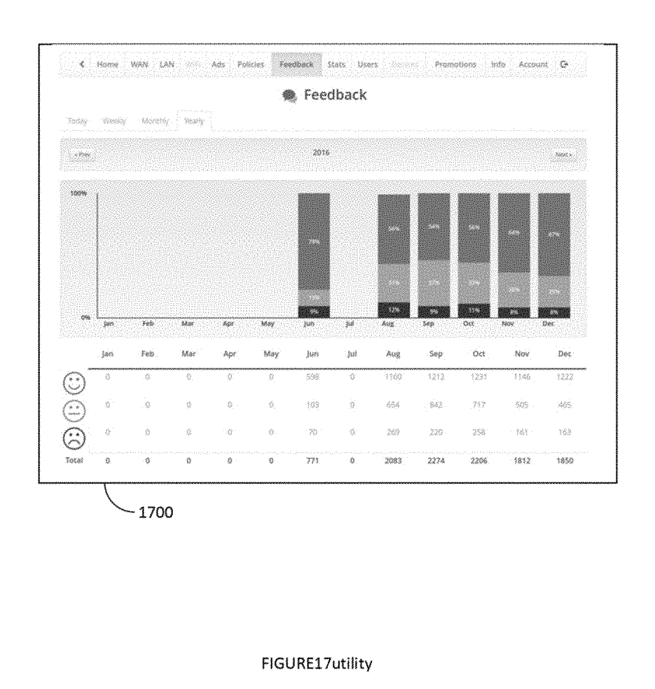

FIG. 17 illustrates an example screen shot 1700, accordingly to some embodiments. Example screen shot 1700 can display a set of year-wise statistics in the form of a stacked bar graph for each month of the year along with total count across each of the three categories for all months of that year. The user can have the option to switch backwards to the previous year or forward to the next year.

This real-time feedback system over guest Wi-Fi is activated when a user selects an appropriate Wi-Fi network and the login page is presented, but before the guest has authenticated and Internet access has been granted. Guest responses and data sit locally at a venue's premises. Guests can leave feedback electronically in a platform that also then enables full connection to the Internet. The platform stores the guest data entirely onsite and is entirely owned by the property owner and not accessible remotely unless desired.

Cloud-hosted configuration panel is a portal wherein a venue administrator/owner can view the dashboard when their device is connected to the Internet, at anytime from anywhere with Internet access. To view the same on local configuration panel, the administrator is to be present at the venue and connected to hotspot.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium),

In addition, it can be, appreciated that the various operations, processes, and methods disclosed herein can be embodied in a machine-readable medium an/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computerized method useful for recording guest feedback on a captive portal before granting internet access through a venue's Wi-Fi hotspot comprising
providing a captive portal, wherein the captive portal comprises web page that is shown before allowing a guest's computing device's web browser to access the Internet via a venue's Wi-Fi network;
with the web page provided by the captive portal presenting the guest with a feedback form wherein the feedback form is hosted locally in a local gateway controller integrated in the captive portal; and
obtaining a guest's feedback from a guest input in the feedback form.

2. The computerized method of claim 1, wherein a Wi-Fi hotspot is provided with a gateway controller integrated in the captive portal.

3. Th computerized method of clams 1, wherein the venue's Wi-Fi network comprises a hotel's Wi-Fi network.

4. The computerized method of claim 1 further comprising:
recording a geolocation of the venue along with the guest feedback from the feedback form.

5. The computerized method of claim 1 further comprising:
generating a user interface (UI) within a locally-hosted configuration panel; and
with the locally-hosted configuration panel, generating an electronic-message alert based on the type of feedback recorded.

6. The computerized method of claim 5, wherein the electronic-message alert comprises an email'generated by an email-generation system in the locally- hosted configuration panel, and wherein the email is electronically communicated to pre-registered email address owned by the venue.

7. The computerized method of claim 5, wherein the electronic-message alert comprises an instant message generated by an instant message-generation system ire the locally-hosted configuration panel, and wherein the instant message is electronically communicated to pre-registered instant message application owned by the venue.

8. The computerized method of claim 5 further comprising:
receiving, with the locally-hosted configuration panel, from a venue administrator a set of key words, and
wherein the type of feedback recorded comprises at least one key word of the set of key words.

9. The computerized, method of claim 6 further comprising:
aggregating a set of feedback from a plurality of guests for a specified period.

10. A computer system useful for recording guest feedback on a captive portal before granting internet access through a venue's Wi-Fi hotspot comprising:
a processor;
a memory containing instructions when executed on the processor, causes the processor to perform operations that:
providing a captive portal, wherein the captive portal comprises a web page that is shown before allowing a guest's computing device's web browser to access the Internet via a venue's Wi-Fi network;
with the web page provided by the captive portal, presenting the guest with a feedback form, wherein the feedback form is hosted locally in a local gateway controller, and
obtaining a guest's feedback from a guest input in the feedback form.

11. The computer system of claim 10, wherein a Wi-Fi hotspot is provided with a gateway controller integrated in the captive portal.

12. The computer system of claim 11, wherein the venue's Wi-Fi network comprises a hotel's Wi-Fi network.

13. The computer system of claim 12, wherein the memory containing instructions when executed on the processor, causes the processor to perform operations that further:
record a geolocation of the venue along with the guest feedback from the feedback form.

14. The computer system of claim 13, wherein the memory containing instructions when executed on the processor, causes the processor to perform operations that further:
generate a user interface (UI) within a configuration panel; and
with the configuration panel, generates an electronic-message alert based on the type of feedback recorded.

15. The computer system of claim 14, wherein the electronic-message alert comprises an email generated by an email-generation system in the hosted configuration panel, and wherein the email is electronically communicated to pre-registered email address owned by the venue.

16. The computerized method of claim 14, wherein the electronic-message alert comprises an instant message generated by an instant message-generation system in the hosted configuration panel, and wherein the instant message is electronically communicated to pre-registered instant message application owned by the venue.

17. The computerized method of claim 15 further comprising:
receiving, with the configuration panel, from a venue administrator a set of key words, and
wherein the type of feedback recorded comprises at least one key word of the set of key words.

18. The computerized method of claim 17, wherein the configuration panel comprises a locally hosted configuration panel.

19. The computerized method of claim 17, wherein the configuration panel comprises a cloud-hosted configuration panel.

20. The computerized method of claim 16 further comprising:
aggregating a set of feedback from a plurality of guests for a specified period, wherein the aggregated feedback is stored locally at the venue not accessible by a remote computing system;
configuring for display with a dashboard accessible by the venue administrator.
